(19) United States
(12) Patent Application Publication
(10) Pub. No.: US 2009/0168165 A1
(43) Pub. Date: Jul. 2, 2009

(54) System and Method for Combined 3-D Imaging and Full Video Using a Single Lenticular Lens Sheet

(76) Inventor: Anthony L. Hoffman, Eagan, MN (US)

Correspondence Address: James V. Lilly;Kagan Binder, 221 Main Street North, Suite 200 Maple Island Bldg, Stillwater, MN, 55082, US

(21) Appl. No.: 12/226,845

(22) PCT Filed: May 10, 2007
(86) PCT No.: PCT/US07/11307

§ 371 Date: Oct. 29, 2008

Related U.S. Application Data
(60) Provisional application No. 60/800,933, filed on May 17, 2006.

(51) Int. Cl. G02B 27/22

(52) U.S. Cl. 359/463

(57) ABSTRACT

A method of creating a lenticular display and a lenticular display having a three-dimensional (3-D) lenticular image and a lenticular animation on the same display is disclosed. The lenticular display is formed by providing at least two related images in a first image sequence, the first image sequence being related to the 3-D lenticular image and providing a second image sequence made up of more than one image related to the 3-D lenticular image, the images of the second image sequence being sequenced to provide an animation. The display is further formed by interlacing the first and second image sequences into an interlaced image such that the first image sequence is repeated at least two times per lenticule.

### REFERENCE TO RELATED APPLICATIONS

This application claims the benefit of U.S. Provisional Patent Application having Ser. No. 60/800,933, filed on May 17, 2006, entitled “System and Method for Combined 3-D Imaging and Full Motion Video Using a Single Lenticular Lens Sheet”, the entire disclosure of which is incorporated herein by reference for all purposes.

### BACKGROUND

The invention relates generally to lenticular images. In particular the invention relates generally to the production of three-dimensional (3-D)) lenticular images and full motion video using a single lenticular lens sheet.

Lenticular images provide the user with an illusory effect of movement and three dimensional depth in an image. The effect is created by a combination of lenticular lenses (a series of lenticules), formed as a sheet, and an underlying lenticular image. The lenticular image is typically a computer generated segmented image. The segmented image can be a series of images that are stripped and interlaced. A viewer looks through the lenticular lens sheet and an image is assembled from the segmented interlaced images thus constructing a single image which has depth and/or appears to move depending on the visual angle. The lenticules may be a variety of shapes such as, cylindrical, pyramidal, trapezoidal or parabolic. Lenticular lens sheets are generally well known and commercially available.

A lenticular image is generated through the use of two components, a printed interlaced image and a lenticular lens screen through which the image is viewed. The first step is to prepare two or more images and then use a program to interlace them. Since a lenticular image displays one image after another as the angle of view is changed, the lenticular image may be used to create animations much like an old fashioned flipbook. For this reason, each image in such an instance is called a flip. The more flips used the more complicated planning and preparation become. However, there exists conventionally the capability to include 30 or more flips on a single lenticular card, which would be roughly equivalent to a full one second (30 frames per second) of full motion video.

Conventionally, an interlacing software program is used to take selected images and cut them into very narrow strips. The interlacing software then interlaces these strips like a perfectly shuffled deck of cards. For example, if two flips are being created, the first band is a strip from image 1, the second band is a strip from image 2, the third from image 1, and so on. The interlacing software is used to save the interlaced image in a file ready for printing.

The second step is mounting a printed interlaced image behind the lenticular lens screen or more preferably printing the interlaced image directly onto the lenticular lens screen. The lenticular lens screen is conventionally a sheet of plastic on which a series of cylindrical lenses are molded in parallel rib-like rows. Each of these lenses are called lenticules. Each lenticule typically has a focal length equal to the thickness of the clear plastic sheet on which it is molded. Each lenticule magnifies a very narrow strip of the image placed behind it. If you change your angle of view, the strip that is being magnified also changes.

Because people have two eyes that each view objects, including lenticular cards, at slightly different angles (often referred to as parallax), a 3-D image may be created using a lenticular lens screen. Three-dimensional images are conventionally created by taking pictures of the same object or scene from different angles. When the images are interlaced, and mounted to a lenticular lens screen, one eye sees one image and the second eye sees a second image which was taken at a different angle, thus the image will appear to have 3-D depth. Alternatively, a series of images may be created by computer generating apparent different angles through computer processes, or by using images from a 3-D graphics computer model which may be rotated on a display. The images are then captured in a sequential manner, and interlaced.

Conventionally, to produce 3-D lenticular image effects, a lenticular lens sheet having lenticules with a relatively narrow viewing angle is used. Although, it may be possible to use lenticular lens sheets with moderate and wide viewing angles, the 3-D image effect will be less effective and may lack a sense of depth. In contrast, when producing full motion video or animated video sequences, lenticular lens sheets having wide or ultra wide viewing angles are conventionally used. Therefore, conventionally it has not been possible to produce an effective lenticular display having both full motion video in a portion of the lenticular display and effective 3-D image effects in another portion of the display using only a single lenticular lens sheet. Accordingly, there is need for a system and method of producing a lenticular display using a single lenticular lens sheet that is especially effective in showing full motion video and 3-D image effects in different portions of the display.

Further, a limitation of 3-D lenticular images which are produced using a narrow angle lenticular lens sheet is that the 3-D image may be viewed over a relatively small viewing angle while providing a good depth effect. Accordingly there is also a need for a system and method of producing 3-D lenticular image displays having a relatively wide viewing angle while retaining a good 3-D depth effect.

Further still, conventional full motion video display sheets may display the full motion video sequence as a viewer walks by the display in one direction. A limitation is seen in that the video is presented in the reverse sequence to a viewer walking by the display in the other direction. Accordingly, there is a need for a system and method for displaying full motion video that is viewed in sequence in two different directions while using a single lenticular lens sheet.

The techniques herein below extend to those embodiments which fall within the scope of the appended claims, regardless of whether they accomplish one or more of the above-mentioned needs.

### SUMMARY

Alternative exemplary embodiments relate to other features and combination of features and combination of features as may be generally recited in the claims.

What is provided is a method of creating a display having a three-dimensional (3-D) image and an animation on the same display, the display having a light steering optical element in the form of a barrier screen having a plurality of slits in the barrier screen or a lenticular sheet having a plurality of lenticules in a lenticular sheet. The method comprises providing at least two related images in a first image sequence. The first image sequence is related to the 3-D image. The method also comprises providing a second image sequence made up of more than one image related to the 3-D image. The images of the second image sequence are sequenced to provide an animation. The method further comprises interlacing the first and second image sequences into an interlaced image such that the first image sequence is repeated at least two times per slit or lenticule.

What is also provided is a method of creating a three-dimensional (3-D) image. The method comprises providing a light steering optical element sheet comprising parallel lenticules or slits. The method also comprises providing at least two related images in a first image sequence. The images are representative of parallax views of at least one object in the image. Further, the method comprises interlacing the image sequence into an interlaced image. Further still, the method comprises positioning the interlaced image to underlie the lenticules or slits with strips of the image sequence being repeated at least once under each lenticule or slit.

Further, what is provided is a display sheet displaying a three dimensional image. The display sheet comprises a light steering optical element sheet and an interlaced image coupled to the light steering optical element sheet. The interlaced image is made up of a first image sequence where the first image sequence is repeated at least once under each lenticule or slit.

Further still, what is provided is a display sheet displaying a three dimensional image. The display sheet comprises a single light steering optical element sheet having a series of uniform lenticules or slits. Further, the display comprises an interlaced image coupled to the light steering optical element sheet, the interlaced image is made up of a first image sequence and by a second image sequence. The first image sequence comprises related images. The images are related as parallax views of at least one object in the image and the second image sequence comprising related images, the images are related as images forming at least one of an animation sequence and a flip sequence. The image slices of the first image sequence are repeated at least one time under each lenticule or slit.

### BRIEF DESCRIPTION OF THE DRAWINGS

A better understanding of the features and advantages of the present invention will be obtained by reference to the following detailed description that sets forth illustrative embodiments by way of example only, in which the principles of the invention are utilized, and the accompanying drawings, of which:

FIG. 1 is an exemplary cross section of a lenticular card for producing 3-D lenticular images;

FIG. 2 is an exemplary cross section of lenticules and schematically depicting interlaced image strips in accordance with an exemplary embodiment and further depicting a display sheet; and

FIG. 3 is an exemplary block diagram of an exemplary method of generating a combined three-dimensional and full motion video lenticular display sheet.

### DETAILED DESCRIPTION

Before describing in detail the particular improved system and method, it should be observed that the invention includes, but is not limited to a novel structural combination of conventional lenticular imaging components, and not in the particular detailed configurations thereof. Accordingly, the structure, methods, functions, control and arrangement of conventional components structural elements have, for the most part, been illustrated in the drawings by readily understandable block representations and schematic diagrams, in order not to obscure the disclosure with structural details which will be readily apparent to those skilled in the art, having the benefit of the description herein. Further, the invention is not limited to the particular embodiments depicted in the exemplary diagrams, but should be construed in accordance with the language in the claims.

Lenticular 3-D images are a composite of two or more composite interlaced pictures and the lenticular lenses are arranged with the segmented portions to provide the desired image effect. The flat back surface of the lens sheet lays over the interlaced image or the image is printed directly onto the flat back surface of the lens sheet. The image is then viewed through the lens sheet.

Early lenticular technology used both the lenticular image and lenticular lenses as separate components. Conventionally today, the lenticular image is printed directly on to the flat back surface of the lenticular sheet as taught in U.S. Pat. Nos. 5,457,515 and 6,424,467, the disclosures of which are incorporated herein by reference in their entirety.

As a point of reference and sometimes confusion, lenticular imaging is distinct from holographic imaging. Holographic imaging utilizes a three-dimensional image that is created using lasers. Because both holographic imagery and lenticular images can display depth, the techniques are sometimes confused. Holographic images do not use lenticular lenses, but rather use etching as a means of creating a desired effect.

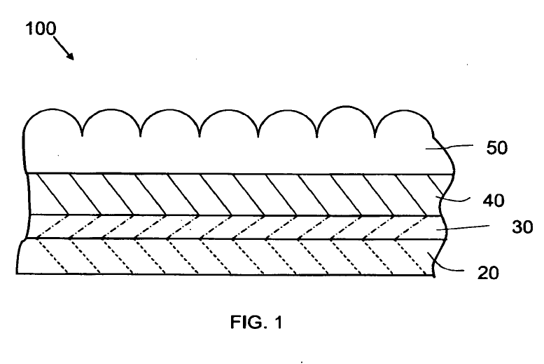

Referring now to FIG. 1, FIG. 1 illustrates a cross section of a lenticular card embodiment in accordance with the invention. A backing sheet 20, for example, an opaque or clear plastic such as a vinyl laminate layer, is coated with an adhesive layer 30, such as but not limited to, a glue or resin formulation. An optional core sheet, for example, an opaque or clear plastic sheet, can be situated between adhesive layer 30 and image layer 40. It is understood that when an optional core sheet is used, a second adhesive layer 37 may be used between the optional core sheet and image layer 40. Image layer 40 can be formed using a variety of materials and methods, such as but not limited to, a curable ink or alternatively a separate image sheet. The lenticular lens top sheet 50 can be formed from a variety of materials, including but not limited to, a clear plastic sheet, a polyvinyl chloride (PVC) sheet, an amorphous polyethylene terephthalate (APET). An optional primer layer (not shown) can be interposed between layers 20-30, 30-40, or 40-50 for better bonding between the layers.

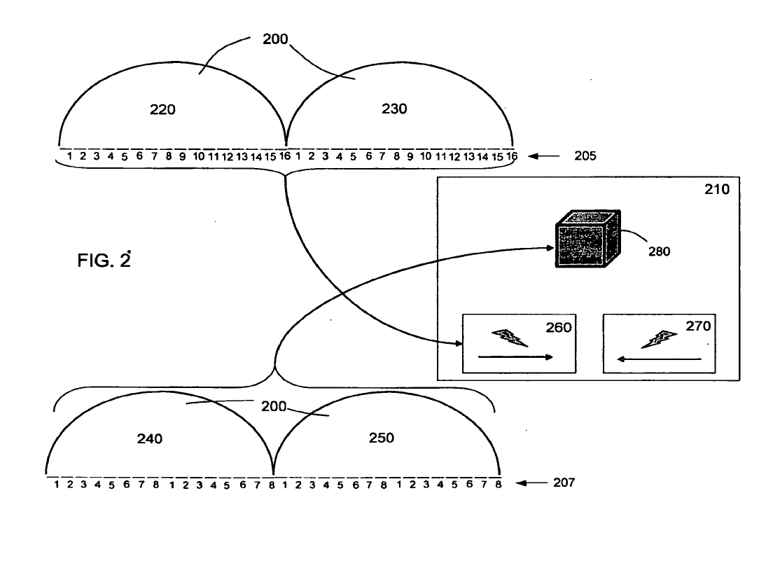

Referring to FIG. 2, FIG. 2 is an exemplary diagram of lenticules with strips (phases) of the interlaced images below each lenticule in accordance with an exemplary embodiment. The numbers below each strip represent the image that the strip was formed from. For example, lenticules 200 overlay interlaced images 205 and 207. Display sheet 210 is formed from a single lenticular lens sheet having a series of substantially uniform lenticules 200. The strips of the interlaced image 205 are numbered, in this exemplary case 1-16 as the interlaced image was formed from 16 separate images. The strips of the interlaced image 207 are numbered 1-8 in this exemplary case. Images 205 are provided to produce full motion video in a display area 260. Alternatively, images 205 may be a series of images producing one or more flips. Images 207 are provided to produce a 3-D image 280 on display 5 sheet 2 1 0.

Conventionally, the desired sequencing for 3-D images is to move the foreground and the background elements in opposing direction. This is done using strips of multiple images each under one lenticule and then restarting the cycle of strips under the adjacent lenticule, and so on. Conventional 3-D effects use a narrow viewing angle lenticular lens sheet, having a viewing angle on the order of 30 degrees. Lenticular lens sheets with larger viewing angles may also be used however yielding a less desirable 3-D effect. Furthermore, when using a wide viewing angle lenticular lens sheet in a conventional 3-D application, a viewer viewing the display sheet from a relatively lengthy distance, may not view the scene as 3-D or may view the scene as a poor 3-D rendition. Because of the large viewing angle combined with the lengthy viewing distance, the parallax effect is minimized or nonexistent to a viewer. Thus, it may be seen that the 3-D producing technique described below for use with relatively large viewing angle lenticular lens sheets solves this problem.

In accordance with an exemplary embodiment, in which a lenticular lens sheet with a larger viewing angle (on the order of 60 degrees) is used, it may be desirable to have 3-D effects with one or more objects in the image. Placing all of a sequence of image strips under one lenticule and repeating the sequence under the next lenticule and so on may yield a 3-D image effect, however the effect will likely be undesirable, lacking depth or a feeling of three dimensions. Therefore, in accordance with an exemplary embodiment, the sequence of images may be repeated two or more times under each lenticule.

With reference to FIG. 2, a lenticular lens display sheet 210 comprises a lenticular lens sheet having lenticules 200. Sequenced image strips 207 30 are positioned under lenticules 240 and 250 to yield a 3-D image of an object 280 on display sheet 210. As can be seen sequenced image strips, in this exemplary embodiment, comprise 8 different images of object 280. The 8 images have been interlaced to form the sequences underlying lenticules 240 and 250. It should be noted that lenticules 240 and 250 are merely representative of the lenticules under which the images lay that form object 280. Many more lenticules on the order of 1200 lenticules, for example, are used to cover the area spanned by image 280. In accordance with an exemplary embodiment, more than one sequence, in this example two sequences of image strips 1-8 of sequenced image strips 207, underlie each of the lenticules to form the 3-D image 280. Image 280 will therefore result in an image having greater depth and a more desirable 3-D effect than if there were only a single sequence of image strips underlying lenticules 240 and 250. Because of the use of multiple image sequences under each lenticule, moderate, wide, and ultra-wide viewing angle lenticular lens sheets may be used while still providing a desirable 3-D effect.

Lenticular lens sheet displays are also used effectively for doing flips, animation, or full motion video sequences. A lenticular lens sheet with a relatively wide viewing angle is desirably used for video or animation sequences. Conventionally, because of the need for a wide angle lens sheet for video and animation and a narrow angle lens sheet for 3-D effects, it has been thought that animations or full motion video and 3-D effects using the same lenticular lens sheet was incompatible. However, in accordance with an exemplary embodiment using a relatively wide viewing angle lenticular lens sheet and image sequences for 3-D such as sequences 207 in which the sequence is repeated under each lenticule, both desirable 3-D image effects and animation and/or full motion video may be produced using a single lenticular lens sheet.

For example referring again to FIG. 2, lenticular lens sheet display 210 comprises a relatively wide angle lenticular lens sheet providing a 3-D image 280 using image sequences 207. An animation area 260 is provided in which animation sequences 205 are used under lenticules 220 and 230. In this example, the animation is formed from images 1-16 which are stripped and interlaced and underlie lenticules 220 and 230 and others in the animation area 260. The animation in area 260 is produced in a conventional manner in which the entire stripped sequence of images is under a single lenticule and repeated under each lenticule. Accordingly, by applying the sequencing in a manner such as sequencing 207 and applying that sequencing in a portion of the display where a 3-D effect is desired and applying conventional sequencing in areas where animation is desired, desirable 3-D effects and animation or video may be combined on a single lenticular lens display sheet using a single lenticular lens sheet that is designed for animation. In a particular exemplary embodiment it may be desirable to have a viewer see a specific frame of an animation or of a flip sequence while viewing the 3-D scene at a specific apparent viewing angle. Because the composite image sequence (video or animation combined with 3-D scene) may be interlaced into a single image through a computerized process, and a single lenticular lens sheet is being used, the images corresponding to the images which are to appear simultaneously may be aligned under each lenticule. For example, image 8 of animation 260 may be designed to appear to a viewer at the same time as the first occurrence of image 8 of 3-D scene 280.

This combination of effects may be used in any of a variety of display applications, including but not limited to cards, inserts, books, cups, posters, etc. In an exemplary embodiment display sheet 210 may be a poster, for example a movie poster in which a static 3-D image is represented by object 280. Areas 260 and 270 may be reserved for a short video or animation sequence. The video may be properly sequenced for a user approaching the poster from the left and moving past the poster to the right, in animation area 260. The image sequence may then be reversed for area 270 so that a person approaching the poster from the right and moving to the left may view the image sequence in the proper order. To do this, sequence 205 would be the reverse of that for area 260, in area 270.

Any configuration for display sheet 210 may be created using the detailed techniques. Further, the invention is not limited to the number of sequences, the number of images, or the number of different areas shown. Further still, one of ordinary skill in the art would appreciate the fact that a number of different types of lenticular lens sheets having a range of different viewing angles and sizes may be used without departing from the scope of the invention.

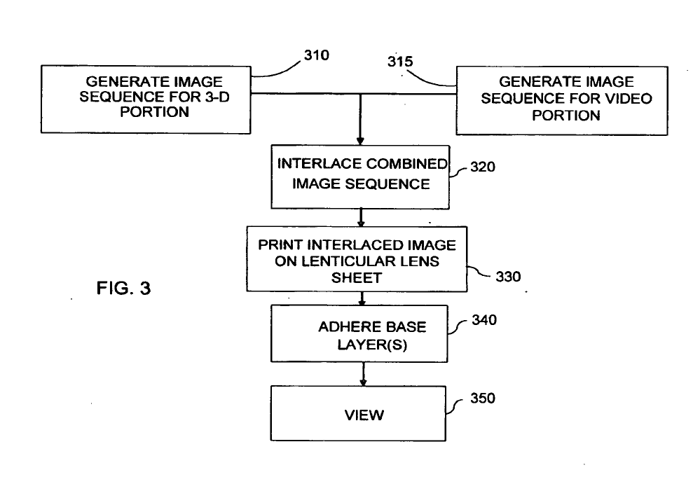

Referring now to FIG. 3, a process for assembling a combined 3-D and video lenticular display sheet is depicted. To assemble such a display sheet, the image sequence for the 3-D portion is generated (process 310) and the image sequence for the animation or video portion is generated (process 315). These two portions are merged into a single interlaced image. In another exemplary embodiment it may be possible to generate the image as a composite image that does not need to be merged, but has at least two distinct portions. Once the composite images are generated, an interlaced image is created (process 320). This interlaced image is then printed on the lenticular lens sheet (process 330) and a base layer is adhered to the lenticular lens sheet (process 340). The display sheet may then be viewed having both 3-D images and animation or video images thereon (process 350). An example of this is the following sequence for a 75 lines per inch (LPI) lens with a 2400 dots per inch (DPI) output device used. Sequencing might typically be in the following order using either 1,200 or 2,400 DPI: Phases 1,2,3,4,5,6,7,8,9,10,11,12,13,14,15,16, under lenticule 240 and then restart the sequence with 1,2,3,4,5,6,7,8,9,10,11,12,13,14,15,16, under lenticule 250. Once applied, the effects can enhance lenticular product in any shape, contour or purpose. For example, flat, curved, warped, glued, and molded are some examples of the products which may be desired by a customer desiring a 3-D lenticular product. Also, the technique described may be beneficial in manufacturing, in that both 3-D effects and animation effects may be included on a single display sheet during a gang run, even where it is desired to cut the display sheet into parts each of which have only an animation or a 3-D image effect. Conventionally, this could not be accomplished because one would be required to print a gang run having sheets with only 3-D effects and another separate gang run having only animations.

In accordance with an alternative exemplary embodiment, parallax barrier methods may be used instead of a lenticular screen, to generate a similar effect. Parallax barrier methods were known about in the early 1900's, they include the parallax stereogram and the related parallax panoramagram. The parallax stereogram consists of a fine vertical grating placed in front of an interlaced image. The parallax stereogram utilizes two separate images. The grating is normally made of an opaque material with fine transparent vertical splits at a regular spacing. Each transparent slit acts as a window to a vertical slice of the image placed behind it, the exact slice depends on the position of the eye.

Parallax panoramagrams use not just a pair of images but a larger number of images. These can be images in a time ordered sequence in which case tilting the panoramagram will give the impression of motion or three dimensions. Similar to the lenticular image creation, the image behind the barrier is formed by laying strips from each subimage next to each other to form an interlaced image. In accordance with an alternative embodiment, lenticular lens sheet 210 of FIG. 2 may be replaced by a barrier screen comprising a transparent sheet having a plurality of parallel, evenly spaced barrier strips thereby forming a grating. The barrier screen sheet or grating just like the lenticular lens sheet are both forms of light steering optical elements. In the same way that a 3-D image may be generated using a lenticular lens sheet where an image sequence is repeated under a single lenticle, using a barrier screen or grating the same general effect may be achieved by providing a repeated image sequence under each slit of the barrier screen.

Because much of the image is occluded, it may be beneficial to print onto a transparent sheet and back light the transparent sheet. It may also be desirable to mount the image in a special light box or frames.

While the detailed drawings, specific examples, and particular formulations given described exemplary embodiments, they serve the purpose of illustration only. It should be understood that various alternatives to the embodiments of the invention described maybe employed in practicing the invention. It is intended that the following claims define the scope of the invention and that structures within the scope of these claims and their equivalents be covered thereby. The lenticular imaging component configurations shown and described may differ depending on the chosen performance characteristics and physical characteristics of the resultant lenticular product. For example, the type of materials, the number of lines per inch of the lenticular lens sheet, the resolution and type of the printer imaging equipment being used, the software being used, the resultant product configuration, and the resultant desired effect may differ. The systems shown and described are not limited to the precise details and conditions disclosed. Method steps provided may not be limited to the order in which they are listed but may be ordered any way as to carry out the inventive process without departing from the scope of the invention. Furthermore, other substitutions, modifications, changes and omissions may be made in the design, operating conditions and arrangements of the exemplary embodiments without departing from the scope of the invention as expressed in the appended claims.

What is claimed is:

1. A method of creating a display having a three-dimensional (3-D) image and an animation on the same display, the display having a light steering optical element in the form of a barrier screen having a plurality of slits in the barrier screen or a lenticular sheet having a plurality of lenticules in a lenticular sheet, comprising:
providing at least two images in a first image sequence, the first image sequence being related to the 3-D image;
providing a second image sequence made up of more than one image, the images of the second image sequence being sequenced to provide an animation; and
interlacing the first and second image sequences into an interlaced image such that the first image sequence is repeated at least two times per slit or lenticule.

2. The method of claim 1, further comprising:
providing a light steering optical element sheet having a set of relatively uniform lenticules or slits on the sheet.

3. The method of claim 2, further comprising:
printing the interlaced image on the sheet.

4. The method of claim 2, further comprising:
aligning the interlaced image on the sheet.

5. The method of claim 2, further comprising:
printing the interlaced image on a backside of the sheet.

6. The method of claim 2, further comprising:
depositing a primer layer on the backside of the sheet.

7. The method of claim 1, wherein the second image sequence comprises a video sequence.

8. The method of claim 2, further comprising:
coupling a backing layer to the sheet.

9. A method of creating a three-dimensional (3-D) image, comprising:
providing a light steering optical element sheet comprising parallel lenticules or slits;
providing at least two related images in a first image sequence, the images being representative of parallax views of at least one object in the image;
interlacing the image sequence into an interlaced image; and
positioning the interlaced image to underlie the lenticules or slits with strips of the image sequence being repeated at least once under each lenticule or slit.

10. The method of claim 9, further comprising:
providing a single lenticular lens sheet having a set of relatively uniform lenticules or slits on the sheet.

11. The method of claim 10, further comprising:
printing the interlaced image on a separate sheet.

12. The method of claim 11, further comprising:
aligning the sheet on the sheet.

13. The method of claim 10, further comprising:
printing the interlaced image on a backside of the sheet.

14. The method of claim 10, further comprising:
depositing a primer layer on the backside of the sheet.

15. The method of claim 10, wherein the sheet has lenticules or slits with viewing angles greater than 30 degrees.

16. The method of claim 10, further comprising:
coupling a backing layer to the sheet.

17. The method of claim 10, further comprising:
providing a second image sequence having images representative of an animation, where interlaced strips of the second image sequence are not repeated under each lenticule or slit.

18. A display sheet displaying a three-dimensional image, comprising
a light steering optical element sheet having at least one of a plurality of parallel slits, or a plurality of parallel lenticules; and
an interlaced image coupled to the light steering optical element sheet, the interlaced image made up of a first image sequence where the first image sequence is repeated at least once under each lenticule or slit.

19. The display sheet of claim 18, wherein the format of the display sheet is a poster.

20. A display sheet displaying a three-dimensional image, comprising
a single light steering optical element sheet comprising a series of uniform lenticules or slits; and
an interlaced image coupled to the light steering optical element sheet, the interlaced image made up of a first image sequence and by a second image sequence, the first image sequence comprising related images, the images being related as parallax views of at least one object in the image and the second image sequence comprising related images, the images being related as images forming at least one of an animation sequence and a flip sequence,
wherein image slices of the first image sequence are repeated at least one time under each lenticule or slit.

21. The display sheet of claim 20, wherein the slices of the first image define a 3-D image area of the display sheet and slices of the second image sequence define a first animation or flip area of the display sheet.

22. The display sheet of claim 20, further comprising:
a third image sequence that is the reverse of the second sequence, the third image sequence being interlaced and forming a portion of the interlaced image.

23. The display sheet of claim 22, wherein the slices of the third image sequence define a second animation or flip area of the display sheet

24. The display sheet of claim 20, wherein the display sheet is printed in a gang run.
